(19) United States
(12) Patent Application Publication
(10) Pub. No.: US 2024/0006117 A1
(43) Pub. Date: Jan. 4, 2024

(54) COIL DEVICE

(71) Applicant: TDK CORPORATION, Tokyo (JP)

(72) Inventors: Atsushi SHOJI, Tokyo (JP); Masaru KUMAGAI, Tokyo (JP)

(73) Assignee: TDK CORPORATION, Tokyo (JP)

(21) Appl. No.: 18/334,702

(22) Filed: Jun. 14, 2023

(30) Foreign Application Priority Data
Jun. 29, 2022 (JP) 2022-104927
Jun. 29, 2022 (JP) 2022-104935

(51) Int. Cl. H01F 27/32; H01F 27/29; H01F 27/30; H01F 5/04; H01F 27/02

(52) U.S. Cl. CPC H01F 27/325; H01F 27/29; H01F 27/306; H01F 5/04; H01F 27/022

(57) ABSTRACT

A coil device includes a coil, a terminal, a bobbin, and a core. The coil includes a winding portion and a lead portion drawn out from the winding portion. The terminal is connected with the lead portion. The bobbin includes a cylinder portion for the winding portion and a terminal installation portion formed at an end in a first direction parallel to an axial direction of the cylinder portion and provided with the terminal. The core is attachable to the bobbin. The terminal installation portion includes a convex portion separating the core and the terminal.

### BACKGROUND OF THE INVENTION

The present disclosure relates to a coil device used as a transformer or the like.

As a coil device used as a transformer or the like, for example, there is a coil device disclosed in Patent Document 1. The coil device of Patent Document 1 includes a coil, a bobbin for a winding portion of the coil, a terminal connected with a lead portion of the coil, and a core attachable to the bobbin. The bobbin includes a cylinder portion for the winding portion of the coil and a terminal installation portion formed at an end of the cylinder portion in its axial direction and provided with the terminal.

In the coil device of Patent Document 1, the end of the core in its longitudinal direction is disposed at the terminal installation portion and is close to the terminal. Thus, it is difficult to ensure a creepage distance between the core and the terminal, and the insulation between the core and the terminal may deteriorate. If the length of the terminal installation portion is extended along the axial direction of the cylinder portion for the purpose of ensuring the creepage distance between the core and the terminal, it becomes difficult to miniaturize the coil device.

In this type of coil device, the lead portion may be drawn out toward the terminal over the winding portion. If the distance between the winding portion and the lead portion becomes smaller due to the progress of miniaturization of the coil device, the insulation distance between them becomes smaller, and the insulation may deteriorate. If the distance between the winding portion and the lead portion is increased for the purpose of ensuring the insulation distance between the winding portion and the lead portion, it becomes difficult to achieve miniaturization and low profile of the coil device.
Patent Document 1: JPH09186024 (A)

### BRIEF SUMMARY OF THE INVENTION

The present disclosure has been achieved under such circumstances. It is an object of the disclosure to provide a compact coil device with excellent insulation between a core and a terminal or between a winding portion and a lead portion.

To achieve the above object, a coil device according to the first aspect of the present disclosure comprises:
a coil including:
   a winding portion; and
   a lead portion drawn out from the winding portion;
a terminal connected with the lead portion;
a bobbin including:
   a cylinder portion for the winding portion; and
   a terminal installation portion formed at an end in a first direction parallel to an axial direction of the cylinder portion and provided with the terminal; and
a core attachable to the bobbin,
wherein the terminal installation portion includes a convex portion separating the core and the terminal.

In the coil device according to the present disclosure, the terminal installation portion includes a convex portion separating the core and the terminal. Thus, since the core and the terminal are arranged opposite to each other via the convex portion, the convex portion can extend a creepage distance or a spatial distance (insulation distance) between the core and the terminal. Thus, even if a part of the core is disposed close to the terminal, it is possible to ensure the insulation between the core and the terminal and achieve a compact coil device with excellent (withstand voltage) reliability.

The convex portion may protrude toward a third direction perpendicular to an installation surface of the bobbin. In this case, the insulation distance between the core and the terminal can be extended according to the protrusion length of the convex portion in the third direction.

The convex portion may extend from one end to the other end of the terminal installation portion along a second direction perpendicular to the first direction and the third direction. Also, a length of the convex portion may be equal to or larger than a length of the core in a second direction perpendicular to the first direction and the third direction. In this case, a wall-like convex portion can be formed on the terminal installation portion, and the insulation distance between the end of the core in the first direction and the terminal can be extended according to the length of the convex portion along the second direction.

The terminal may comprise a pair of terminals, and the convex portion may be formed at least between the pair of terminals. In this case, it is possible to prevent the insulation distance between the core and the terminal from being locally shortened between the pair of terminals.

The bobbin may comprise a first bobbin and a second bobbin, and at least a part of the second bobbin may be accommodated in the first bobbin. When at least a part of the second bobbin is accommodated in the first bobbin, it is possible to shorten the length of the bobbin along the first direction and miniaturize the coil device.

The coil may comprise: a first coil including a first winding portion; and a second coil including a second winding portion, the first bobbin may include a first cylinder portion for the first winding portion, the second bobbin may include a second cylinder portion for the second winding portion and for the core to be inserted, and the second cylinder portion may be inserted into the first cylinder portion. In this case, for example, the coil device can be functioned as a transformer, and in particular, a compact transformer can be achieved.

The convex portion may comprise a first convex portion and a second convex portion, the terminal installation portion may comprise: a first terminal installation portion formed at one end of the first cylinder portion in the first direction; and a second terminal installation portion formed at the other end of the second cylinder portion in the first direction, the first terminal installation portion may include the first convex portion, and the second terminal installation portion may include the second convex portion. Even if the first terminal installation portion is provided with the first convex portion and the second terminal installation portion is provided with the second convex portion in this way, since the cylinder portion is divided into the first cylinder portion and the second cylinder portion, the core can be inserted into the cylinder portion (second cylinder portion) without being hindered by the first convex portion or the second convex portion.

The core may comprise: a first core; and a second core combined with the first core, the first core may be an I-shaped core, the second core may be a U-shaped core, and the first core may be inserted into the cylinder portion. In this case, the first core and the second core can form an annular core, and the magnetic characteristics of the coil device can thereby be improved.

A length of the first core along the first direction may be larger than a length of the second core along the first direction. In this case, even if a contact portion between the first core and the second core is positionally displaced due to a positional displacement of the first core and/or the second core in the first direction, the area of the contact portion (cross-sectional area of the magnetic path at the contact portion) can be prevented from varying.

An end of the first core in the first direction may be connected to the terminal installation portion via a resin on an outer side of a contact portion between the first core and the second core in the first direction. In this case, since the end of the first core in the first direction is fixed to the terminal installation portion via a resin, it is possible to prevent the positional displacement of the first core.

The terminal installation portion may include a first stopper formed on an inner side of the convex portion in the first direction and contacted with an end of the core in the first direction. In this case, the core can be positioned in the first direction by the first stopper. Moreover, it is possible to prevent the insulation distance between the core and the terminal from varying (decreasing) due to the positional displacement of the core.

The first stopper may include a step formed between an upper surface of the first stopper and an installation surface of the bobbin for the core to be mounted. In this case, the core can be positioned in the first direction by the step. Moreover, it is possible to prevent the insulation distance between the core and the terminal from varying (decreasing) due to the positional displacement of the core. Moreover, the insulation distance between the core and the terminal can be extended by the step between the upper surface of the first stopper and the installation surface of the bobbin.

The core may be inserted in the cylinder portion, an end of the core in the first direction may protrude outward in the first direction from the cylinder portion, the terminal installation portion may include a second stopper adjacent to the end of the core in the first direction on an outer side of the core in the second direction, and the second stopper may be provided with a notch. In this case, the core can be positioned in the second direction by the second stopper. Moreover, when the second stopper is provided with a notch, for example, when the end of the core in the first direction and the notch are joined with a resin, it is possible to increase the joint area between them and improve the joint strength.

The terminal may include an external connection portion connectable to a substrate, and the external connection portion may protrude toward a direction opposite to a protrusion direction of the convex portion or a direction perpendicular to the protrusion direction. In this case, the coil device can be insertion-mounted or surface-mounted on a substrate via the external connection portion.

To achieve the above object, a coil device according to the second aspect of the present disclosure comprises:
a coil including:
   a winding portion; and
   a lead portion drawn out from the winding portion;
a terminal connected with the lead portion;
a bobbin including:
   a cylinder portion for the winding portion; and
   a terminal installation portion formed at an end in a first direction parallel to an axial direction of the cylinder portion and provided with the terminal;
a core attachable to the bobbin; and
a cover member disposed between the winding portion and the lead portion passing over the winding portion.

In the coil device according to the present disclosure, a cover member is disposed between the winding portion and the lead portion passing over the winding portion. In this case, since the winding portion and the lead portion are arranged opposite to each other via the cover member, the cover member can extend a creepage distance or a spatial distance (insulation distance) between the winding portion and the lead portion. Thus, even if the lead portion is disposed close to the winding portion, it is possible to ensure the insulation between the winding portion and the lead portion and achieve a compact and low-profile coil device with excellent (withstand voltage) reliability.

The lead portion may be drawn out over the winding portion toward the terminal on an opposite side of the core, and the cover member may be attached to the bobbin on the opposite side of the core. In this case, it is possible to ensure the insulation distance between the core and the lead portion and improve the (withstand voltage) reliability of the coil device.

The cover member may include: a cover body; and an opening formed on the cover body, and the lead portion may be drawn out via the opening from the winding portion toward a first surface of the cover body, which is an opposite surface to a surface of the cover body facing the winding portion. In this case, when the lead portion is drawn out from the winding portion toward the first surface of the cover body, it is possible to prevent the lead portion from being bent and prevent the lead portion from being damaged. Moreover, since the lead portion can be drawn out in a short distance from the winding portion toward the first surface of the cover body, it is possible to increase the number of turns of the winding portion.

The opening may extend from an outer edge of the cover body toward an inner side of the cover body. In this case, the lead portion can be guided into the opening from the outer edge of the cover body toward the inner side of the cover body.

The cover member may include: a cover body; and a first guide portion formed on the cover body and protruding from the cover body, and the first guide portion may be formed on a first surface of the cover body, which is an opposite surface to a surface of the cover body facing the winding portion. The lead portion can be guided in a desired direction (extension direction of the first guide portion) by drawing the lead portion along the first guide portion. Moreover, the lead portion can be protected from external loads by drawing the lead portion along the first guide portion.

A height of the first guide portion may be equal to or larger than a wire diameter of the lead portion. In this case, for example, the lead portion can be guided in a desired direction (extension direction of the first guide portion) while being fixed to the first guide portion.

The terminal installation portion may include a second guide portion protruding toward the opposite side of the core. In this case, the lead portion can be guided in a desired direction (extension direction of the second guide portion) by drawing the lead portion along the second guide portion. Moreover, the lead portion can be protected from external loads by drawing the lead portion along the second guide portion.

The second guide portion may protrude in the same direction as the first guide portion and extend along the first direction. In this case, the lead portion can be drawn out from the winding portion to the terminal along the first guide portion and the second guide portion.

### BRIEF DESCRIPTION OF THE DRAWING(S)

FIG. 1A is a perspective view of a coil device according to First Embodiment;

FIG. 1B is a perspective view of the coil device shown in FIG. 1A as viewed from another angle;

FIG. 2 is an exploded perspective view of the coil device shown in FIG. 1A;

FIG. 3 is a cross-sectional view of the coil device shown in FIG. 1A along the line III-III;

FIG. 4A is a perspective view of a first bobbin shown in FIG. 2;

FIG. 4B is a perspective view of the first bobbin shown in FIG. 4A as viewed from another angle;

FIG. 5 is a perspective view of a second bobbin shown in FIG. 2;

FIG. 6 is a bottom view of the first bobbin and the second bobbin shown in FIG. 2;

FIG. 7 is a perspective view of a first cover member shown in FIG. 2;

FIG. 8 is a bottom view of the first cover member attached to the first bobbin;

FIG. 9 is a perspective view of a second cover member shown in FIG. 2; and

FIG. 10 is a perspective view of a coil device according to Second Embodiment.

### DETAILED DESCRIPTION OF THE INVENTION

Embodiments of the present disclosure are described with reference to the drawings. Although the embodiments of the present disclosure are described with reference to the drawings as necessary, the illustrated contents are only schematically and exemplarily shown for understanding of the present disclosure, and the appearance, dimensional ratio, etc. may be different from the actual one. Hereinafter, the present disclosure is specifically described based on the embodiments, but is not limited to these embodiments.

### First Embodiment

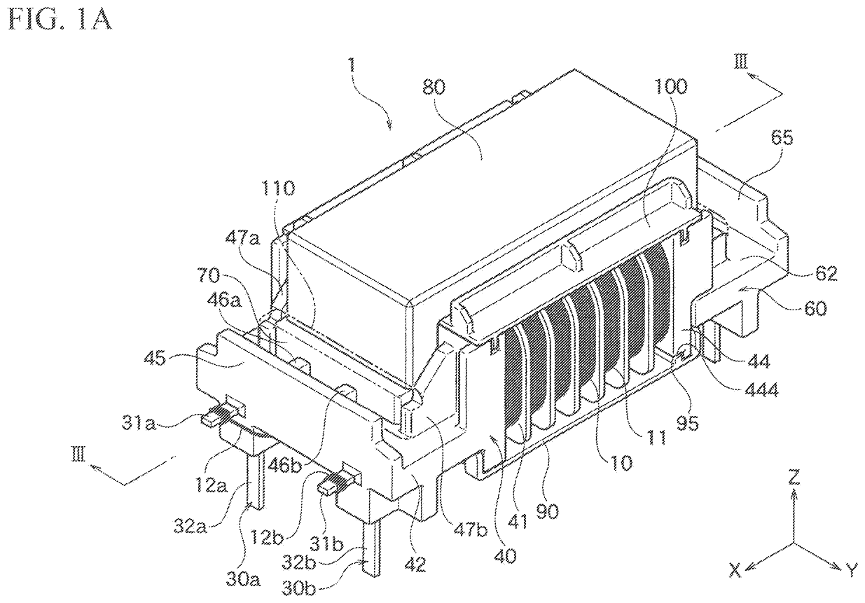

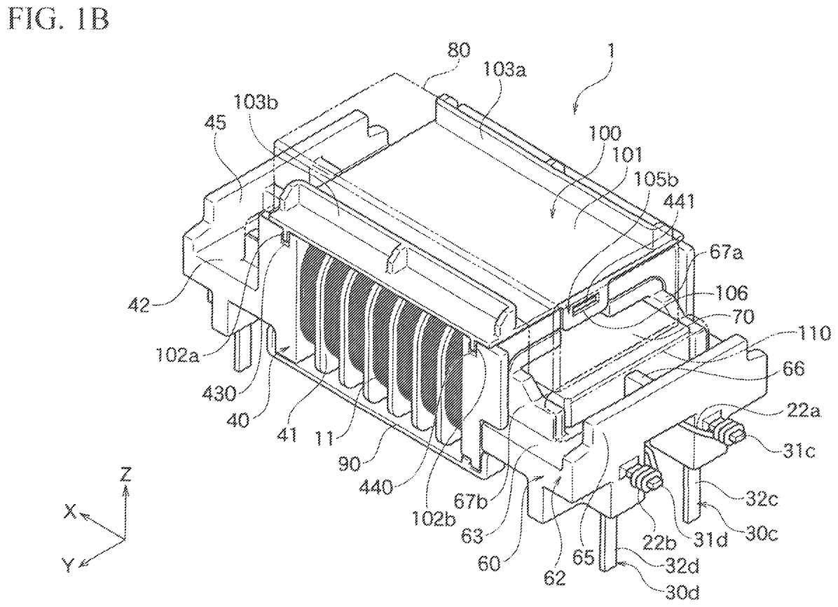

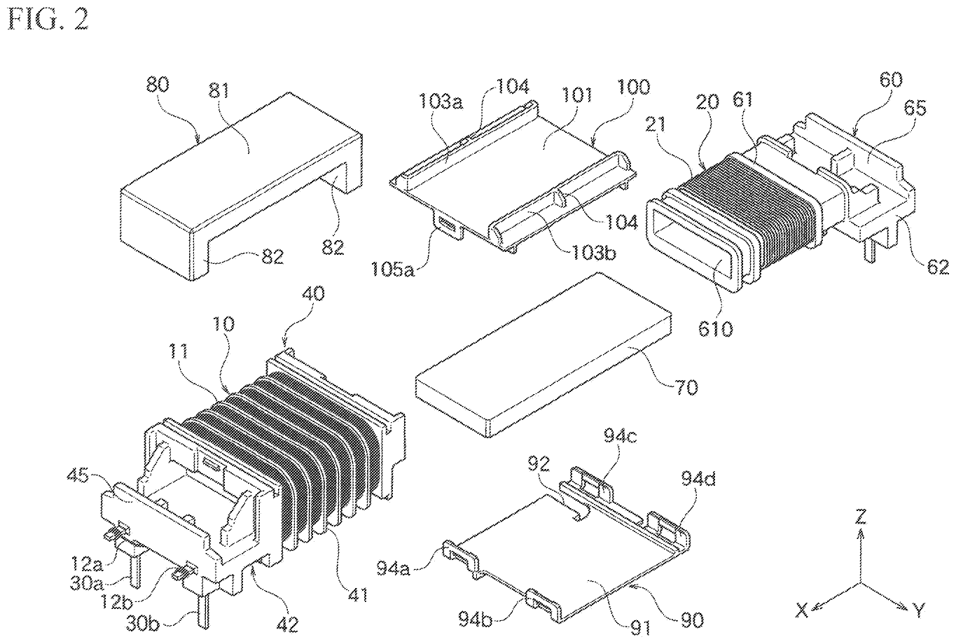

A coil device 1 of the present embodiment shown in FIG. 1A and FIG. 1B can be used, for example, as a transformer (i.e., step-up transformer). As shown in FIG. 2, the coil device 1 includes a first coil 10, a second coil 20, terminals 30a to 30d (FIG. 1B), a first bobbin 40, a second bobbin 60, a first core 70, a second core 80, a first cover member 90, and a second cover member 100.

In the figures, the X-axis is an axis corresponding to the longitudinal direction (axial direction) of the first bobbin 40, the Y-axis is an axis corresponding to the lateral direction of the first bobbin 40 (or the arrangement direction of the terminals 30a and 30b), and the Z-axis is an axis perpendicular to the X-axis and the Y-axis.

Hereinafter, the positive side of the Z-axis direction is referred to as “upper”, and the negative side of the Z-axis direction is referred to as “lower”. Regarding each of the X-axis, Y-axis, and Z-axis, the direction toward the center of the coil device 1 is referred to as “inner side”, and the direction away from the center of the coil device 1 is referred to as “outer side”.

The coil device 1 is a horizontal coil device in which the axis of the first bobbin 40 is disposed in parallel to a mounting board (not shown). In the present embodiment, “parallel” is not limited to being strictly parallel and includes an error within ±10 degrees. The same applies to “perpendicular”, and “perpendicular” is not limited to being strictly perpendicular and includes an error within ±10 degrees.

For example, the length of the coil device 1 along the X-axis is 30 to 50 mm, the length of the coil device 1 along the Y-axis is 10 to 20 mm, and the length of the coil device 1 along the Z-axis is 10 to 25 mm. However, the size of the coil device 1 is not limited to this.

The first coil 10 is formed on the first bobbin 40. The first coil 10 includes a winding portion 11 having a coil shape and lead portions 12a and 12b drawn out from the winding portion 11. The second coil 20 is formed on the second bobbin 60. The second coil 20 includes a winding portion 21 having a coil shape and lead portions 22a and 22b (FIG. 1B) drawn out from the winding portion 21. In the present embodiment, the first coil 10 constitutes a secondary coil, and the second coil 20 constitutes a primary coil, but this relation may be reversed.

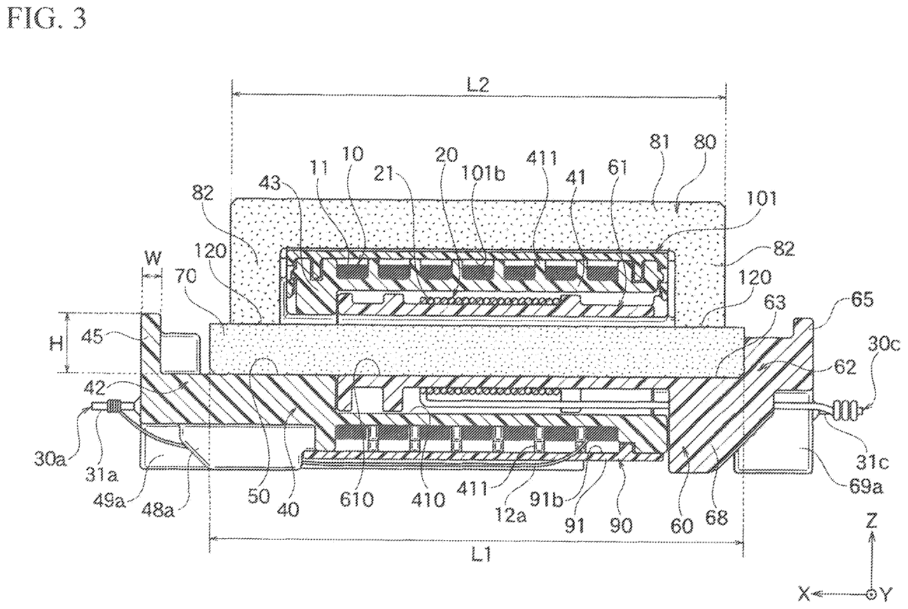

As shown in FIG. 3, the winding portion 11 is formed of five layers along the radial direction of the first bobbin 40, but may be formed of four or less layers or six or more layers. The winding portion 21 is formed of one layer along the radial direction of the second bobbin 60, but may be formed of plural layers.

The wires for constituting the first coil 10 and the second coil 20 are not limited, but are insulated wires. The core material of the wires is, for example, copper wire. The wires may be single wires or pair wires. The wire size (diameter) of the wires is not limited and is, for example, 0.1 to 1.0 mm. The wire size of the wire constituting the second coil 20 is larger than the wire size of the wire constituting the first coil 10, but the wire sizes of the wires may be equal to each other. In the present embodiment, “equal” is not limited to being exactly equal, but includes an error of ±10% or less between objects to be compared.

As shown in FIG. 1A and FIG. 1B, the terminals 30a to 30d have the same shape, but may have different shapes. The shape of the terminals 30a to 30d is not limited, but is an L shape. The terminals 30a to 30d are made of a conductor such as metal. The terminals 30a to 30d may include wire connection portions 31a to 31d and external connection portions 32a to 32d. The lead portion 12a (one lead portion) of the first coil 10 (FIG. 2) is connected to the wire connection portion 31a, and the lead portion 12b (the other lead portion) of the first coil 10 is connected to the wire connection portion 31b. The lead portion 22a (one lead portion) of the second coil 20 (FIG. 2) is connected to the wire connection portion 31c, and the lead portion 22b (the other lead portion) of the second coil 20 is connected to the wire connection portion 31d.

The external connection portions 32a to 32d are connected to an external substrate (not shown). The external connection portions 32a to 32d protrude downward, but the protrusion direction of the external connection portions 32a to 32d is not limited to this. For example, the external connection portions 32a to 32d may protrude along the X-axis. Instead, the external connection portions 32a to 32d may protrude diagonally with respect to the Z-axis. In the present embodiment, the coil device 1 can be insertion-mounted or surface-mounted on an external substrate via the external connection portions 32a to 32d.

As shown in FIG. 2, the first core 70 is an I-shaped core having a rectangular parallelepiped shape. The second core 80 is a U-shaped core. The second core 80 includes a body portion 81 having a rectangular parallelepiped shape and leg portions 82 protruding from both ends of the body portion 81 in the X-axis direction. The protrusion direction of the leg portions 82 is a direction perpendicular to the body portion 81.

The first core 70 and the second core 80 may be made of, for example, a material containing a magnetic substance and a resin or may be a sintered body of a metal magnetic substance. Examples of the magnetic material forming the first core 70 and the second core 80 include ferrite particles such as Mn—Zn based ferrite, metal magnetic particles, and the like.

As shown in FIG. 1A, the first core 70 and the second core 80 are attached directly or indirectly to the first bobbin 40. As shown in FIG. 3, the second core 80 is combined with the first core 70. For more detail, one leg portion 82 is contacted with the surface of the first core 70 at one contact portion 120, and the other leg portion 82 is contacted with the surface of the first core 70 at the other contact portion 120. In the present embodiment, the first core 70 and the second core 80 can form an annular core, and the magnetic characteristics of the coil device 1 can thereby be improved.

The length L1 of the first core 70 along the X-axis may be larger than the length L2 of the second core 80 along the X-axis. In this case, the end of the first core 70 on the positive side of the X-axis direction may protrude outward by, for example, 1 mm or more along the X-axis from one contact portion 120. Also, the end of the first core 70 on the negative side of the X-axis direction protrudes outward along the X-axis from the other contact portion 120. In case of L1>L2, even if the position of each of the contact portions 120 is displaced due to the positional displacement of the first core 70 and/or the second core 80 in the X-axis direction, the area of each of the contact portions 120 (cross-sectional area of the magnetic path of the annular core at the contact portion 120) can be prevented from varying.

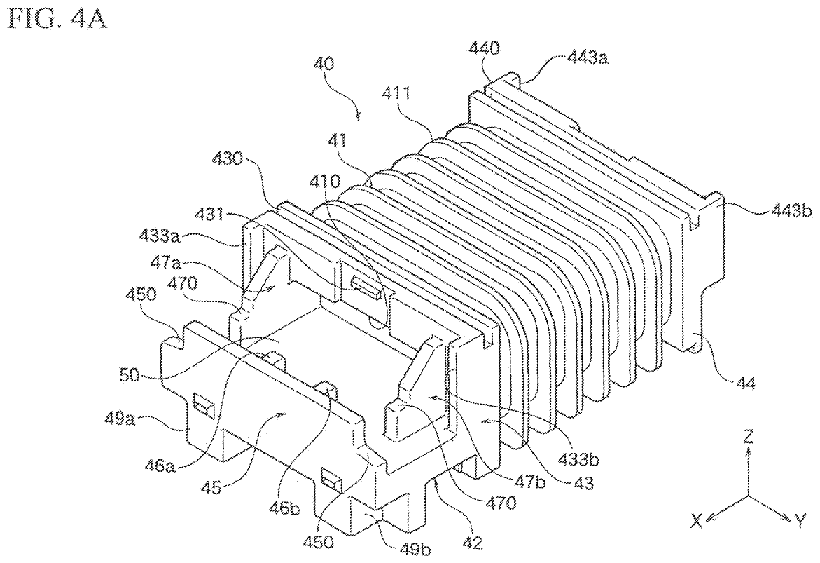

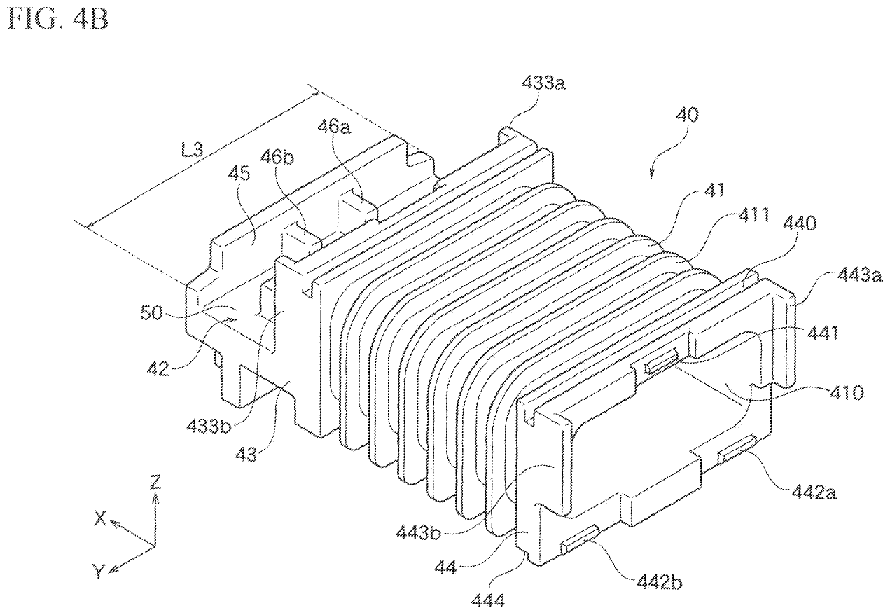

As shown in FIG. 4A and FIG. 4B, the first bobbin 40 includes a cylinder portion 41, a terminal installation portion 42, and flange portions 43 and 44. The flange portions 43 and 44 may be omitted. The first bobbin 40 is made of, for example, plastic, such as PPS, PET, PBT, and LCP, or other insulating materials (e.g., heat-resistant materials).

The cylinder portion 41 is formed of a cylindrical body and includes a through hole 410 and partition walls 411. The axial direction of the cylinder portion 41 corresponds to the X-axis direction. The cross-sectional shape of the cylinder portion 41 perpendicular to its axial direction is rectangular (oblong), but is not limited to this. The winding portion 11 (FIG. 2) is formed on the outer circumferential surface of the cylinder portion 41.

The through-hole 410 is formed from one end to the other end of the cylinder portion 41 along the X-axis. At least a part of the second bobbin 60 (FIG. 2) can be inserted (accommodated) into the cylinder portion 41.

The partition walls 411 are formed on the outer circumferential surface of the cylinder portion 41. The partition walls 411 protrude radially outward from the outer circumferential surface of the cylinder portion 41 and extend along the circumferential direction of the cylinder portion 41. The partition walls 411 may encircle the cylinder portion 41 along its circumferential direction.

In the present embodiment, a plurality (e.g., six) of partition walls 411 is formed on the outer circumferential surface of the cylinder portion 41. The plurality of partition walls 411 partitions the outer circumferential surface of the cylinder portion 41 into a plurality of sections along the X-axis. Thus, among the plurality of sections, the winding portion 11 (FIG. 2) can be formed in any section. Note that, in the present embodiment, as shown in FIG. 2, the winding portion 11 is formed on the cylinder portion 41 so as to straddle all sections.

As shown in FIG. 4A, the flange portion 43 is formed at the end of the cylinder portion 41 on the positive side of the X-axis direction, and the flange portion 44 is formed at the end of the cylinder portion 41 on the negative side of the X-axis direction. The flange portions 43 and 44 protrude radially outward from the outer circumferential surface of the cylinder portion 41 and extend along the circumferential direction of the cylinder portion 41.

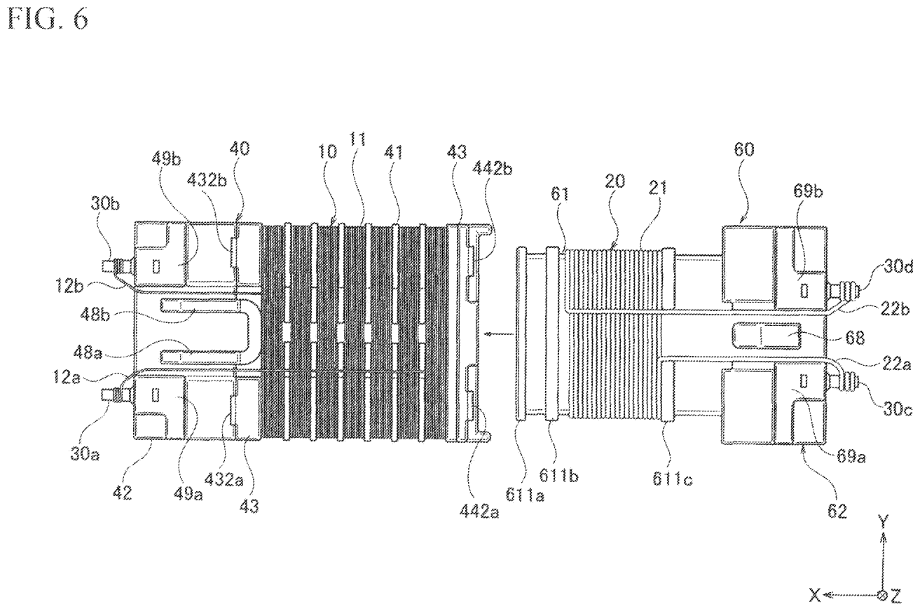

The flange portion 43 may include an engagement groove portion 430, an engagement convex portion 431, and side wall portions 433a and 433b. The engagement groove portion 430 is formed on an upper part of the flange portion 43 and extends from one end to the other end of the flange portion 43 along the Y-axis. The engagement convex portion 431 is formed on the upper end surface of the flange portion 43 and protrudes outward in the X-axis direction. The side wall portion 433a is formed on the negative side of the flange portion 43 in the Y-axis direction and protrudes outward in the X-axis direction. The side wall portion 433b is formed on the positive side of the flange portion 43 in the Y-axis direction and protrudes in the same direction as the side wall portion 433a. As shown in FIG. 6, engagement convex portions 432a and 432b may be formed on a lower part of the flange portion 43. The engagement convex portions 432a and 432b protrude outward in the X-axis direction.

As shown in FIG. 4B, the flange portion 44 may include an engagement groove portion 440, an engagement convex portion 441, engagement convex portions 442a and 442b, side wall portions 443a and 443b, and an engagement recess 444. The engagement groove portion 440 is formed on an upper part of the flange portion 44 and extends from one end to the other end of the flange portion 44 along the Y-axis. The engagement convex portion 441 is formed on the upper end surface of the flange portion 44 and protrudes outward in the X-axis direction. The engagement convex portions 442a and 442b are formed on the lower end surface of the flange portion 44 and protrude outward in the X-axis direction. The side wall portion 443a is formed on the negative side of the flange portion 44 in the Y-axis direction and protrudes outward in the X-axis direction. The side wall portion 443b is formed on the positive side of the flange portion 44 in the Y-axis direction and protrudes in the same direction as the side wall portion 443a. The engagement recess 444 is formed on a lower part of the flange portion 44 and extends from one end to the other end of the flange portion 44 along the Y-axis.

The second cover member 100 (FIG. 2) is attached to the engagement grooves 430 and 440 and the engagement convex portions 431 and 441 shown in FIG. 4A and FIG. 4B. Also, the first cover member 90 (FIG. 2) is attached to the engagement convex portions 432a and 432b and the engagement convex portions 442a and 442b shown in FIG. 6.

As shown in FIG. 4A, the terminal installation portion 42 is formed continuously with the cylinder portion 41 at the end of the cylinder portion 41 on the positive side of the X-axis direction. The terminal installation portion 42 protrudes outward in the X-axis direction from the end of the cylinder portion 41 on the positive side of the X-axis direction.

As shown in FIG. 1A, the terminal installation portion 42 is provided with the terminals 30a and 30b. The terminals 30a and 30b are arranged separately along the Y-axis. The terminals 30a and 30b may be molded integrally (insertion-molded) with the terminal installation portion 42 or may be attached afterward to the terminal installation portion 42. The wire connection portions 31a and 31b protrude outward in the X-axis direction from the terminal installation portion 42, and the external connection portions 32a and 32b protrude downward from the terminal installation portion 42.

As shown in FIG. 4A, the terminal installation portion 42 includes a convex portion 45, first stoppers 46a and 46b, second stoppers 47a and 47b, guide portions 48a and 48b (FIG. 6), protrusion portions 49a and 49b, and an installation surface 50. The first core 70 (FIG. 3) is mounted on the installation surface 50.

The convex portion 45 is formed integrally at the end of the terminal installation portion 42 on the positive side of the X-axis direction and protrudes upward from the installation surface 50. As shown in FIG. 1A, the convex portion 45 is formed between the end of the first core 70 on the positive side of the X-axis direction and the terminals 30a and 30b.

For more detail, at least a part of the convex portion 45 is formed along the X-axis between the end of the first core 70 on the positive side of the X-axis direction and the wire connection portions 31a and 31b exposed from the terminal installation portion 42. Also, at least a part of the convex portion 45 is formed along the Z-axis between the end of the first core 70 on the positive side of the X-axis direction and the external connection portions 32a and 32b exposed from the terminal installation portion 42.

The convex portion 45 has a role of extending a creepage distance and a spatial distance (insulation distance) between the first core 70 and the terminals 30a and 30b by separating the first core 70 and the terminals 30a and 30b between the first core 70 and the terminals 30a and 30b.

As shown in FIG. 3, from the viewpoint of extending the insulation distance between the first core 70 and the terminals 30a and 30b, the height H of the convex portion 45 may be equal to or larger than the thickness of the first core 70 in the Z-axis direction. The height H of the convex portion 45 may be larger than the width W of the convex portion 45 in the X-axis direction. The width W of the convex portion 45 in the X-axis direction is smaller than the thickness of the first core 70 in the Z-axis direction, but may be equal to or larger than the thickness of the first core 70 in the Z-axis direction.

As shown in FIG. 1A, the convex portion 45 extends linearly from one end to the other end of the terminal installation portion 42 along the Y-axis. However, the convex portion 45 may extend from one end to the other end of the terminal installation portion 42 while being bent (curved). Moreover, the convex portion 45 extends continuously from one end to the other end of the terminal installation portion 42, but may extend intermittently. Moreover, the convex portion 45 may extend in an oblique direction with respect to the Y-axis.

From the viewpoint of extending the insulation distance between the first core and the terminals 30a and 30b, the length L3 (FIG. 4B) of the convex portion 45 along the Y-axis may be equal to or larger than the length of the first core 70 along the Y-axis. From a similar point of view, the convex portion 45 may be formed at least between the terminal 30a and the terminal 30b. Moreover, the length L3 (FIG. 4B) of the convex portion 45 may be equal to or larger than the distance along the Y-axis between the terminal 30a and the terminal 30b. Moreover, the length L3 (FIG. 4B) of the convex portion 45 may be smaller than the length of the terminal installation portion 42 along the Y-axis.

The convex portion 45 may be formed on the inner side in the X-axis direction relative to the end of the terminal installation portion 42 on the positive side of the X-axis direction. For example, the convex portion 45 may be formed at any position between the end of the terminal installation portion 42 on the positive side of the X-axis direction and the end of the terminal installation portion 42 on the negative side of the X-axis direction (the end of the cylinder portion 41 on the positive side of the X-axis direction).

The terminal installation portion 42 is provided with one convex portion 45, but may be provided with a plurality of convex portions 45. For example, a plurality of convex portions 45 may be arranged separately along the X-axis. Instead, a plurality of convex portions 45 may be arranged integrally. In this case, it is possible to further extend the insulation distance between the first core 70 and the terminals 30a and 30b. Notches 450 (FIG. 4A) may be formed at both ends of the convex portions 45 in the Y-axis direction.

As shown in FIG. 3, the convex portion 45 protrudes upward from the installation surface 50 above the wire connection portion 31a. As shown in FIG. 1A, the position of the convex portion 45 in the X-axis direction is close to the position of the external connection portions 32a and 32b in the X-axis direction. Note that, the convex portion 45 may be positioned on the outer side of the external connection portions 32a and 32b along the X-axis.

The protrusion direction of the convex portion 45 is opposite to the protrusion direction of the external connection portions 32a and 32b, but is not limited this. The convex portion 45 may protrude in the same direction as the wire connection portions 31a and 31b. For example, the convex portion 45 may protrude outward in the X-axis direction from the end of the terminal installation portion 42 on the positive side of the X-axis direction.

As shown in FIG. 4A, the first stoppers 46a and 46b protrude upward from the installation surface 50. Also, the first stoppers 46a and 46b protrude inward in the X-axis direction from the inner surface of the convex portion 45 in the X-axis direction. The first stoppers 46a and 46b are positioned on the inner side of the convex portion 45 in the X-axis direction and arranged separately along the Y-axis.

As shown in FIG. 1A, the first stoppers 46a and 46b are positioned in the X-axis direction between the convex portion 45 and the end of the first core 70 on the positive side of the X-axis direction. The first stoppers 46a and 46b position the first core 70 in the X-axis direction by contacting with the end of the first core 70 on the positive side of the X-axis direction. Note that, the number of first stoppers may be one or three or more. Also, the first core 70 may not be contacted with the first stoppers 46a and 46b.

As shown in FIG. 4A, the second stoppers 47a and 47b protrude upward from the installation surface 50. Also, the second stoppers 47a and 47b protrude outward in the X-axis direction from the flange portion 43. The second stopper 47a and the second stopper 47b are arranged separately along the Y-axis.

As shown in FIG. 1A, the second stoppers 47a and 47b are arranged adjacent to the end of the first core 70 on the positive side of the X-axis direction on the outer side of the first core 70 in the Y-axis direction. The second stoppers 47a and 47b may be contacted with both ends of the first core 70 in the Y-axis direction and have a role of positioning the first core 70 in the Y-axis direction.

The second stoppers 47a and 47b and the end of the first core 70 on the positive side of the X-axis direction are connected by a resin 110. Also, the end of the first core 70 on the positive side of the X-axis direction is connected to the installation surface 50 via the resin 110. For more detail, the end of the first core 70 on the positive side of the X-axis direction is connected to the installation surface 50 via the resin 110 on the outer side of the contact portion 120 (FIG. 3) in the X-axis direction. Note that, instead of the resin 110, a fixing means, such as an adhesive tape, may be used.

As shown in FIG. 4A, each of the second stoppers 47a and 47b may be provided with a notch 470. In this case, when the end of the first core 70 (FIG. 1A) on the positive side of the X-axis direction and the notches 470 are joined with the resin 110, it is possible to increase the joint area between them and improve the joint strength. Note that, at the position of the notches 470, the height position of the second stoppers 47a and 47b and the position of the upper surface of the first core 70 may be equal to each other.

As shown in FIG. 6, the guide portions 48a and 48b are formed on the bottom of the terminal installation portion 42 and protrude downward from the bottom of the terminal installation portion 42. The protrusion direction of the guide portions 48a and 48b is opposite to the side where the first core 70 and the second core 80 are installed. As shown in FIG. 3, the guide portion 48a (the same applies to the guide portion 48b) extends along the X-axis. The downward protrusion length of the guide portions 48a and 48b may be larger than the wire size (diameter) of the lead portions 12a and 12b.

As shown in FIG. 6, the lead portions 12a and 12b are drawn outward in the X-axis direction over the winding portion 11 toward the terminals 30a and 30b on the bottom surface side of the cylinder portion 41 (the side opposite to the first core 70 and the second core 80). When the lead portions 12a and 12b are led along the guide portions 48a and 48b, respectively, the lead portions 12a and 12b can be guided in a desired direction (extension direction of the guide portions 48a and 48b). Moreover, the lead portions 12a and 12b can be protected from external loads.

As shown in FIG. 4A, the protrusion portions 49a and 49b are formed on the bottom of the terminal installation portion 42 and protrude downward from the bottom of the terminal installation portion 42. The protrusion direction of the protrusion portions 49a and 49b is the same as the protrusion direction of the guide portions 48a and 48b, but is not limited this.

As shown in FIG. 6, for example, the protrusion portions 49a and 49b have a role of guiding the lead portions 12a and 12b in a desired direction (extension direction of the protrusion portions 49a and 49b) together with the guide portions 48a and 48b. Also, for example, the protrusion portions 49a and 49b have a role of protecting the lead portions 12a and 12b from external loads together with the guide portions 48a and 48b.

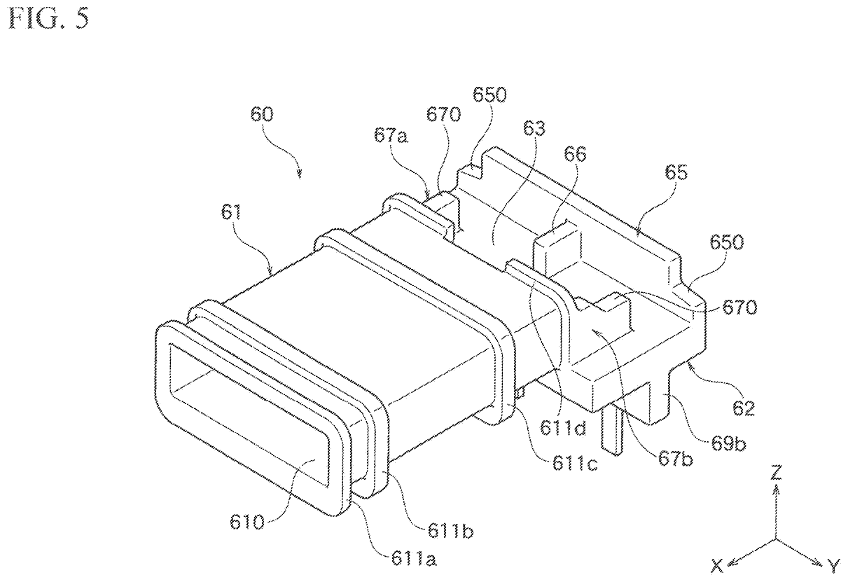

As shown in FIG. 5, the second bobbin 60 includes a cylinder portion 61 and a terminal installation portion 62. The second bobbin 60 is made of the same material as the first bobbin 40, but may be made of a different material.

The cylinder portion 61 is formed of a cylindrical body and includes a through hole 610 and partition walls 611a to 611d. The axial direction of the cylinder portion 61 corresponds to the X-axis direction. The cross-sectional shape of the cylinder portion 61 perpendicular to its axial direction is rectangular (oblong), but is not limited to this. The winding portion 21 (FIG. 2) is formed on the outer circumferential surface of the cylinder portion 61.

The through hole 610 is formed from one end to the other end of the cylinder portion 61 along the X-axis. At least a part of the first core 70 (FIG. 2) can be inserted (accommodated) into the cylinder portion 61.

The partition walls 611a to 611d are formed on the outer circumferential surface of the cylinder portion 61. The partition walls 611a to 611d protrude radially outward from the outer circumferential surface of the cylinder portion 61 and extend along the circumferential direction of the cylinder portion 61. The partition walls 611a to 611d may encircle the cylinder portion 61 along its circumferential direction.

The partition walls 611a to 611d partition the outer circumferential surface of the cylinder portion 61 into a plurality of sections along the X-axis. In the present embodiment, the winding portion 21 (FIG. 2) is formed in the section between the partition wall 611b and the partition wall 611c. The reason why the winding portion 21 is not formed in other sections is to ensure the insulation distance between the winding portion 21 and the first core 70 (FIG. 3) protruding from both ends of the cylinder portion 61 in the X-axis direction. Note that, if necessary, the winding portion 21 may be formed in the cylinder portion 61 so as to straddle other sections.

The terminal installation portion 62 is formed continuously with the cylinder portion 61 at the end of the cylinder portion 61 on the negative side of the X-axis direction. The terminal installation portion 62 protrudes outward in the X-axis direction from the end of the cylinder portion 61 on the negative side of the X-axis direction.

As shown in FIG. 1B, the terminal installation portion 62 is provided with terminals 30c and 30d. The terminals 30c and 30d are arranged separately along the Y-axis. The terminals 30c and 30d may be molded integrally (insertion-molded) with the terminal installation portion 62 or may be attached afterward to the terminal installation portion 62. The wire connection portions 31c and 31d protrude outward in the X-axis direction from the terminal installation portion 62, and the external connection portions 32c and 32d protrude downward from the terminal installation portion 62.

As shown in FIG. 5, the terminal installation portion 62 includes an installation surface 63, a convex portion 65, a first stopper 66, second stoppers 67a and 67b, a guide portion 68 (FIG. 6), and protrusion portions 69a and 69b (FIG. 6). As shown in FIG. 3, the first core 70 is mounted on the installation surface 63. The installation surface 63 may be flush with the bottom surface of the through hole 610 and the installation surface 50. In the present embodiment, “flush” is not limited to being strictly flush and includes an error within ±10%.

As shown in FIG. 5, the convex portion 65 is formed integrally at the end of the terminal installation portion 62 on the negative side of the X-axis direction and protrudes upward from the installation surface 63. As shown in FIG. 1B, the convex portion 65 is formed between the end of the first core 70 on the negative side of the X-axis direction and the terminals 30c and 30d.

Specifically, at least a part of the convex portion 65 is formed along the X-axis between the end of the first core 70 on the negative side of the X-axis direction and the wire connection portions 31c and 31d exposed from the terminal installation portion 62. At least a part of the convex portion 65 is formed along the Z-axis between the end of the first core 70 on the negative side of the X-axis direction and the external connection portions 32c and 32d exposed from the terminal installation portion 62.

The convex portion 65 has a role of extending a creepage distance and a spatial distance (insulation distance) between the first core 70 and the terminals 30c and 30d by separating the first core 70 and the terminals 30c and 30d between the first core 70 and the terminals 30c and 30d.

The shape and size of the convex portion 65 are the same as the shape and size of the convex portion 45 (FIG. 4A). Thus, the matters described for the shape, formation position, size of the convex portion 45 mentioned above (height H, width W, length L3, etc. of the convex portion 45) and their modifications can be applied to the convex portion 65. However, the shape and size of the convex portion 65 may be different from the shape and size of the convex portion 45. For example, the length of the convex portion 65 along the Y-axis may be smaller than the length of the convex portion 45 along the Y-axis. Also, the height of the convex portion 65 may be smaller than the height of the convex portion 45. Notches 650 may be formed at both ends of the convex portion 65 in the Y-axis direction.

As shown in FIG. 3, the convex portion 65 protrudes upward from the installation surface 63 above the wire connection portion 31c. As shown in FIG. 1B, the position of the convex portion 65 in the X-axis direction is close to the position of the external connection portions 32c and 32d in the X-axis direction. The convex portion 65 may be positioned on the outer side of the external connection portions 32c and 32d along the X-axis.

The protrusion direction of the convex portion 65 is opposite to the protrusion direction of the external connection portions 32c and 32d, but is not limited this. The convex portion 65 may protrude in the same direction as the wire connection portions 31c and 31d. For example, the convex portion 65 may protrude outward in the X-axis direction from the end of the terminal installation portion 62 on the negative side of the X-axis direction.

As shown in FIG. 5, the first stopper 66 protrudes upward from the installation surface 63. Also, the first stopper 66 protrudes inward in the X-axis direction from the inner surface of the convex portion 65 in the X-axis direction. The first stopper 66 is located on the inner side of the convex portion 65 in the X-axis direction and disposed in a central part of the terminal installation portion 62 in the Y-axis direction.

As shown in FIG. 1B, the first stopper 66 is positioned in the X-axis direction between the convex portion 65 and the end of the first core 70 on the negative side of the X-axis direction. The first stopper 66 positions the first core 70 in the X-axis direction by contacting with the end of the first core 70 on the negative side of the X-axis direction. Note that, the number of first stoppers 66 may be plural.

As shown in FIG. 5, the second stoppers 67a and 67b protrude upward from the installation surface 63. Also, the second stoppers 67a and 67b protrude outward in the X-axis direction from the partition wall 611d. The second stopper 67a and the second stopper 67b are arranged separately along the Y-axis.

As shown in FIG. 1B, the second stoppers 67a and 67b are arranged adjacent to the end of the first core 70 on the negative side of the X-axis direction on the outer side of the first core 70 in the Y-axis direction. The second stoppers 67a and 67b may be contacted with both ends of the first core 70 in the Y-axis direction and have a role of positioning the first core 70 in the Y-axis direction.

The second stoppers 67a and 67b and the end of the first core 70 on the negative side of the X-axis direction are connected by the resin 110. The end of the first core 70 on the negative side of the X-axis direction is connected to the installation surface 63 via the resin 110. For more detail, the end of the first core 70 on the negative side of the X-axis direction is connected to the installation surface 63 via the resin 110 on the negative side of the contact portion 120 (FIG. 3) in the X-axis direction.

As shown in FIG. 5, each of the second stoppers 67a and 67b may be provided with a notch 670. The function of the notches 670 is similar to the function of the notches 470 (FIG. 4A).

As shown in FIG. 6, the guide portion 68 is formed on the bottom of the terminal installation portion 62 and protrudes downward from the bottom of the terminal installation portion 62. The protrusion direction of the guide portion 68 is opposite to the side where the first core 70 and the second core 80 are installed. As shown in FIG. 3, the guide portion 68 extends along the X-axis. The downward protrusion length of the guide portion 68 may be larger than the wire size (diameter) of the lead portions 22a and 22b.

As shown in FIG. 6, the lead portions 22a and 22b are drawn outward in the X-axis direction over the winding portion 21 toward the terminals 30c and 30d on the bottom surface side of the cylinder portion 61 (the side opposite to the first core 70 and the second core 80). The lead portions 22a and 22b can be guided in a desired direction (extension direction of the guide portion 68) by drawing the lead portions 22a and 22b along the guide portion 68. Moreover, the lead portions 22a and 22b can be protected from external loads.

The protrusion portions 69a and 69b are formed on the bottom of the terminal installation portion 62 and protrude downward from the bottom surface of the terminal installation portion 62. The protrusion direction of the protrusion portions 69a and 69b is the same as the protrusion direction of the guide portion 68, but is not limited this.

For example, the protrusion portions 69a and 69b have a role of guiding the lead portions 22a and 22b in a desired direction (extension direction of the protrusion portions 69a and 69b) together with the guide portion 68. Also, for example, the protrusion portions 69a and 69b have a role of protecting the lead portions 22a and 22b from external loads together with the guide portion 68.

The cylinder portion 61 is inserted into the cylinder portion 41 (through hole 410) in the direction indicated by the arrow in FIG. 6. In the through hole 410, as shown in FIG. 3, the first core 70 is accommodated in the through hole 610, and the cylinder portion 61 with the winding portion 21 wound thereon is accommodated. The end of the cylinder portion 61 on the positive side of the X-axis direction is contacted with the flange portion 43 (the end of the cylinder portion 41 on the positive side of the X-axis direction). That is, the flange portion 43 functions as a stopper for regulating the position of the cylinder portion 61 in the X-axis direction.

At least a part of the winding portion 11 and the winding portion 21 may be opposed to each other in the radial direction. The first core 70 is mounted across the installation surface 50 of the first bobbin 40, the bottom surface of the through hole 610, and the installation surface 63 of the second bobbin 60.

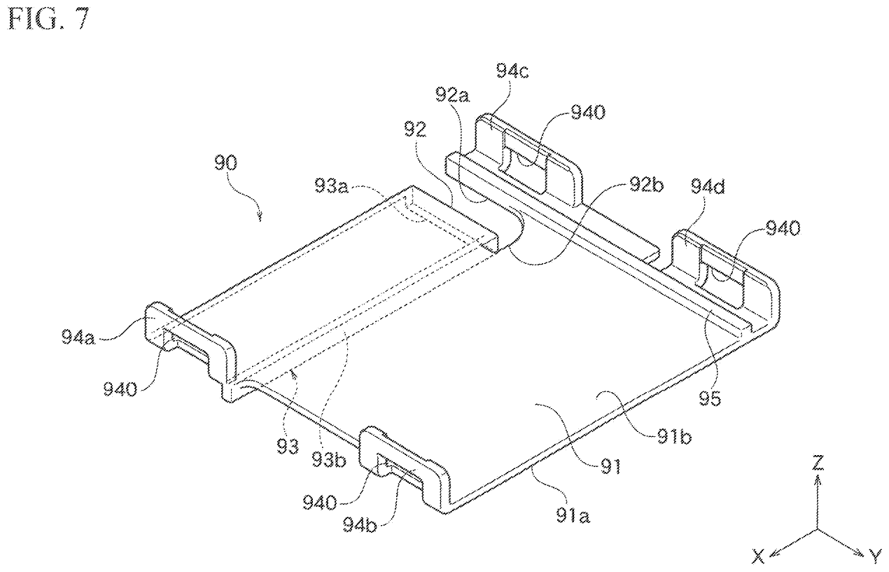

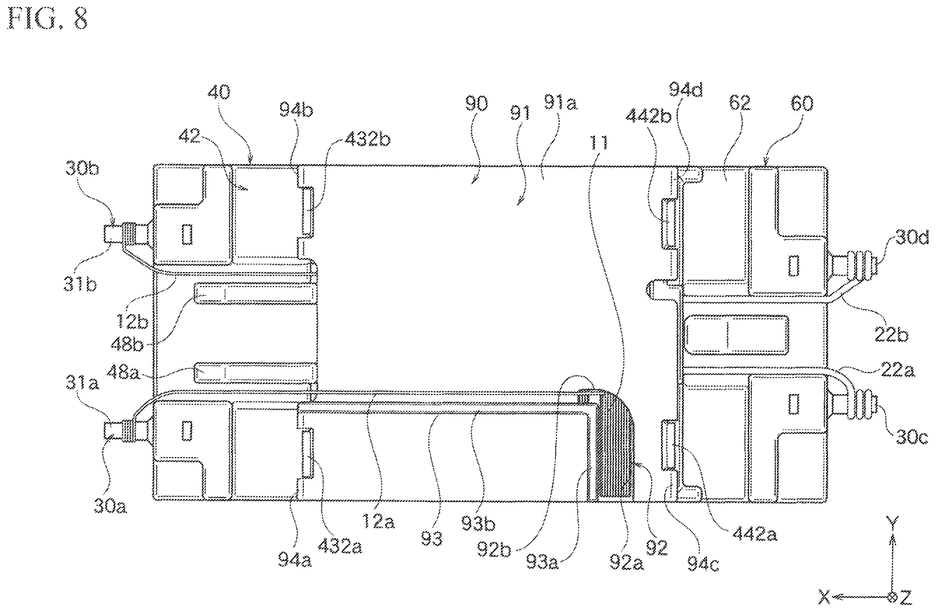

As shown in FIG. 7, the first cover member 90 includes a cover body 91, an opening 92, a guide portion 93, engagement portions 94a to 94d, and an engagement convex portion 95. As shown in FIG. 8, the first cover member 90 is attached to the first bobbin 40 on the bottom surface side of the cylinder portion 41 (the side opposite to the first core 70 and the second core 80). The first cover member 90 may be made of the same material as the first bobbin 40.

As shown in FIG. 7, the cover body 91 may be made of a plate body having a rectangular parallelepiped shape. The cover body 91 includes a first surface 91a and a second surface 91b opposite to the first surface 91a. The first surface 91a is a surface opposite to the cylinder portion 41 (FIG. 4A) and faces outward in the Z-axis direction. The second surface 91b is a surface on the cylinder portion 41 side.

As shown in FIG. 8, the cover body 91 is disposed between the winding portion 11 and the lead portion 12a passing over the winding portion 11 along the X-axis. The cover body 91 has a role of extending a creepage distance and a spatial distance (insulation distance) between the winding portion 11 and the lead portion 12a by separating the winding portion 11 and the lead portion 12a between the winding portion 11 and the lead portion 12a.

The length of the cover body 91 along the X-axis may be equal to or larger than the length of the cylinder portion 41 (FIG. 4A) along the X-axis or the length of the winding portion 11 (FIG. 2) along the X-axis. In either case, it is possible to improve the insulation between the winding portion 11 and the lead portion 12a.

The length of the cover body 91 along the Y-axis is equal to the length of the cylinder portion 41 (FIG. 4A) along the Y-axis, but may be smaller than the length of the cylinder portion 41 along the Y-axis. Also, the length of the cover body 91 along the Y-axis is equal to the length of the winding portion 11 (FIG. 2) along the Y-axis, but may be smaller than the length of the winding portion 11 along the Y-axis. In either case, it is possible to improve the insulation between the winding portion 11 and the lead portion 12a. Note that, the cover body 91 may be disposed locally at the lead position of the lead portion 12a.

As shown in FIG. 3, the second surface 91b of the cover body 91 is contacted with the plurality of partition walls 411 formed on the outer circumferential surface of the cylinder portion 41. Thus, the distance between the cover body 91 and the outer circumferential surface of the cylinder portion 41 is equal to the radial length of the partition walls 411. However, the distance between the cover body 91 and the outer circumferential surface of the cylinder portion 41 may be larger than the radial length of the partition walls 411.

As shown in FIG. 7, the opening 92 penetrates between the first surface 91a and the second portion 92b of the cover body 91 and extends (notched) along the Y-axis from the outer edge of the cover body 91 on the negative side of the Y-axis direction toward the inner side of the Y-axis direction. The opening 92 includes a first portion 92a and a second portion 92b. The first portion 92a extends along the Y-axis direction from the outer edge of the cover body 91 on the negative side of the Y-axis direction toward the inner side of the Y-axis direction. The first portion 92a may extend in a direction inclined with respect to the Y-axis. The first portion 92a has a role of guiding the lead portion 12a from the outer edge of the cover body 91 on the negative side of the Y-axis direction to the inner side of the Y-axis direction.

The second portion 92b is continuous with the first portion 92a and extends along the X-axis. The second portion 92b may extend in a direction inclined with respect to the X-axis. The length of the second portion 92b is smaller than the length of the first portion 92a, but may be equal to or larger than the length of the first portion 92a. The width of the second portion 92b in the Y-axis direction is smaller than the width of the first portion 92a in the X-axis direction, but may be equal to or larger than the width of the first portion 92a in the X-axis direction. The second portion 92b has a role of guiding the lead portion 12a to the positive side of the X-axis direction.

As shown in FIG. 8, the lead portion 12a is drawn out from the winding portion 11 toward the first surface 91a via the opening 92. For example, the lead portion 12a is drawn out via the first portion 92a from the outer edge of the cover body 91 on the negative side of the Y-axis direction toward the inner side of the cover body 91 in the Y-axis direction. Moreover, the lead portion 12a is drawn out via the second portion 92b along the X-axis on (above) the first surface 91a from the inner side of the cover body 91 in the Y-axis direction toward the terminal 30a. Note that, the lead portion 12b is drawn out along the X-axis toward the terminal 30a on (above) the second surface 91b on the cover body 91 (FIG. 7) side of the cover body 91.

The guide portion 93 is formed on the first surface 91a and protrudes outward in the Z-axis direction from the first surface 91a. The height of the guide portion 93 is equal to or larger than the wire size (diameter) of the lead portion 12a, but may be smaller than the wire size of the lead portion 12a.

The guide portion 93 includes a first extension portion 93a and a second extension portion 93b and extends so as to have an L shape. The first extension portion 93a extends along the first portion 92a of the opening 92 from the outer edge of the cover body 91 on the negative side of the Y-axis direction toward the inner side of the cover body 91 in the Y-axis direction. The length of the first extension portion 93a along the Y-axis may be equal to the length of the first portion 92a along the Y-axis. The first extension portion 93a may extend in a direction inclined with respect to the Y-axis. For example, the first extension portion 93a has a role of guiding the lead portion 12a from the outer edge of the cover body 91 on the negative side of the Y-axis direction toward the inner side of the Y-axis direction while hooking the lead portion 12a. Moreover, the first extension portion 93a has a role of extending the creepage distance between the lead portion 12a and the winding portion 11.

The second extension portion 93b is continuous with the first extension portion 93a and extends along the X-axis. A part of the second extension portion 93b extends along the second portion 92b of the opening 92. The second extension portion 93b may extend in a direction inclined with respect to the X-axis. The second extension portion 93b has a role of guiding the lead portion 12a toward the positive side of the X-axis direction while hooking the lead portion 12a. Moreover, the second extension portion 93b has a role of extending the creeping distance between the lead portion 12a and the winding portion 11.

The length of the second extension portion 93b along the X-axis is larger than the length of the first extension portion 93a along the Y-axis, but may be equal to or smaller than the length of the first extension portion 93a. The length of the second extension portion 93b along the X-axis may be, for example, ½ or more of the length of the cover body 91 along the X-axis. The second extension portion 93b extends to the outer edge of the cover body 91 on the positive side of the X-axis direction, but may extend just before the outer edge of the cover body 91 on the positive side of the X-axis direction.

The lead portion 12a is drawn out via the opening 92 from the winding portion 11 toward the first surface 91a and toward the terminal 30a on one side (negative side) of the center of the cover body 91 in the Y-axis direction. However, the drawn out position of the lead portion 12a is not limited and may be at a central part of the cover body 91 in the Y-axis direction.

The second extension portion 93b protrudes in the same direction as the guide portion 48a and extends along the X-axis direction together with the guide portion 48a. Thus, the lead portion 12a can be drawn out from the winding portion 11 to the terminal along the second extension portion 93b and the guide portion 48a. Note that, the guide portion 93 may extend obliquely from the outer edge of the cover body 91 on the negative side of the Y-axis direction toward the outer edge of the cover body 91 on the positive side of the X-axis direction.

As shown in FIG. 7, the engagement portions 94a to 94d are formed at the four corners of the cover body 91 and protrude toward the second surface 91b of the cover body 91. The engagement portions 94a and 94b are arranged separately in the Y-axis direction at the outer edge of the cover body 91 on the positive side of the X-axis direction. The engagement portions 94c and 94d are arranged separately in the Y-axis direction at the outer edge of the cover body 91 on the negative side of the X-axis direction.

Each of the engagement portions 94a to 94d is provided with an engagement hole 940. The engagement holes 940 penetrate through the engagement portions 94a to 94d. As shown in FIG. 8, the engagement holes 940 of the engagement portions 94a and 94b are engaged with the engagement convex portions 432a and 432b of the first bobbin respectively. The engagement holes 940 of the engagement portions 94c and 94d are engaged with the engagement convex portions 442a and 442b of the first bobbin 40, respectively. Thus, the first cover member 90 can be attached to the first bobbin 40.

As shown in FIG. 7, the engagement convex portion 95 is formed on the second surface 91b of the cover body 91 and protrudes from the second surface 91b. The engagement convex portion 95 extends from one end to the other end of the cover body 91 in the Y-axis direction, but the length of the engagement convex portion 95 along the Y-axis is not limited. A part of the engagement convex portion 95 extends along the first portion 92a of the opening 92.

As shown in FIG. 1A, the engagement convex portion 95 is engaged with the engagement recess 444 of the flange portion 44. When the engagement convex portion and the engagement recess 444 are engaged, the first cover member 90 can be prevented from being positionally displaced from the first bobbin 40. Moreover, it is possible to extend the insulation distance between the winding portion 11 and the lead portion 12a.

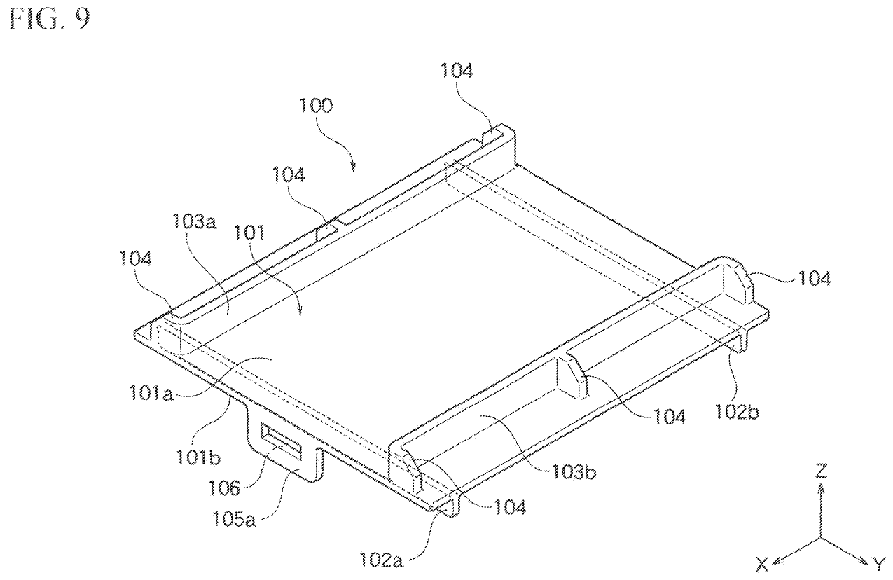

As shown in FIG. 9, the second cover member 100 includes a cover body 101, engagement convex portions 102a and 102b, core restriction portions 103a and 103b, lateral convex portions 104, engagement portions 105a and 105b, and an engagement hole 106. The second cover member 100 may be made of the same material as the first cover member 90. As shown in FIG. 1B, the second cover member 100 is attached to the first bobbin 40 on the upper surface side of the cylinder portion 41 (the side where the second core 80 is disposed).

As shown in FIG. 9, the cover body 101 may be made of a plate body having a rectangular parallelepiped shape. The cover body 101 includes a first surface 101a and a second surface 101b opposite to the first surface 101a. The first surface 101a is a surface facing outward in the Z-axis direction, and the second surface 101b is a surface facing the cylinder portion 41 (FIG. 4A).

As shown in FIG. 1B and FIG. 3, the cover body 101 is disposed between the winding portion 11 and the body portion 81 of the second core 80. The cover body 101 has a role of extending a creepage distance and a spatial distance (insulation distance) between the winding portion 11 and the body portion 81 by separating the winding portion 11 and the body portion 81 between the winding portion 11 and the body portion 81.

The thickness of the cover body 101 in the Z-axis direction is not limited, but may be equal to the thickness of the cover body 91 of the first cover member 90 in the Z-axis direction. The length of the cover body 101 along the X-axis may be equal to or larger than the length of the cylinder portion 41 of the first bobbin 40 along the X-axis or the length of the winding portion 11 along the X-axis. In either case, it is possible to improve the insulation between the winding portion 11 and the body portion 81.

The length of the cover body 101 along the Y-axis may be equal to the length of the cylinder portion 41 along the Y-axis or the length of the winding portion 11 along the Y-axis. Also, the length of the cover body 101 along the Y-axis may be equal to the length of the body portion 81 along the Y-axis. In either case, it is possible to improve the insulation between the winding portion 11 and the body portion 81.

As shown in FIG. 3, the second surface 101b of the cover body 101 is contacted with the plurality of partition walls 411 formed on the outer circumferential surface of the cylinder portion 41. Thus, the distance between the cover body 101 and the outer circumferential surface of the cylinder portion 41 is equal to the radial length of the partition walls 411. However, the distance between the cover body 101 and the outer circumferential surface of the cylinder portion 41 may be larger than the radial length of the partition walls 411.

As shown in FIG. 9, the engagement convex portions 102a and 102b protrude inward in the Z-axis direction from the second surface 101b. The engagement convex portion 102a is formed at the end of the cover body 101 on the positive side of the X-axis direction, and the engagement convex portion 102b is formed at the end of the cover body 101 on the negative side of the X-axis direction. The engagement convex portions 102a and 102b extend from one end to the other end of the cover body 101 in the Y-axis direction, but the length of the engagement convex portions 102a and 102b along the Y-axis is not limited.

The core restriction portions 103a and 103b protrude outward in the Z-axis direction from the first surface 101a. The core restriction portion 103a is formed at the end of the cover body 101 on the negative side of the Y-axis direction, and the core restriction portion 103b is formed at the end of the cover body 101 on the positive side of the Y-axis direction. The core restriction portions 103a and 103b extend from one end to the other end of the cover body 101 in the X-axis direction, but the length of the core restriction portions 103a and 103b along the X-axis is not limited.

As shown in FIG. 1B, the core restriction portions 103a and 103b extend along one end and the other end of the second core 80 in the Y-axis direction, respectively, and are contacted with one end and the other end of the second core 80 in the Y-axis direction. Thus, the core restriction portions 103a and 103b can prevent the second core from being positionally displaced in the Y-axis direction. Moreover, the creepage distance between the winding portion 11 and the second core 80 can be extended by the core restriction portions 103a and 103b.

As shown in FIG. 9, the lateral convex portions 104 protrude outward in the Z-axis direction from the first surface 101a. Also, the lateral convex portions 104 are formed on the outer surfaces of the core restriction portions 103a and 103b in the Y-axis direction and protrude outward in the Y-axis direction from these surfaces. The lateral convex portions 104 have a role of, for example, improving the strength of the cover body 101.

The core restriction portion 103a is provided with three lateral convex portions 104, and the three lateral convex portions 104 are arranged at the respective ends and a central part of the core restriction portion 103a in the X-axis direction. Also, the core restriction portion 103b is provided with three lateral convex portions 104, and the three lateral convex portions 104 are arranged at the respective ends and a central part of the core restriction portion 103b in the X-axis direction. However, the number and arrangement of lateral convex portions 104 are not limited to this. Moreover, it is not necessary for all of the lateral convex portions 104 to have the same shape. For example, the size of the lateral convex portion104 located at a central part of the core restriction portion 103a in the X-axis direction may be smaller.

The engagement portions 105a and 105b (FIG. 1B) are formed at both ends of the cover body 101 in the X-axis direction and protrude toward the second surface 101b. Each of the engagement portions 105a and 105b is provided with the engagement hole 106. The engagement holes 106 penetrate through the engagement portions 105a and 105b. As shown in FIG. 1B, the engagement holes 106 of the engagement portions 105a and 105b are engaged with the engagement convex portions 431 (FIG. 4A) and 441 of the first bobbin 40, respectively. Thus, the second cover member 100 can be attached to the first bobbin 40.

Next, a method of manufacturing a coil device 1 is described. First, each member shown in FIG. 2 is prepared. Terminals 30a and 30b are attached to a terminal installation portion 42 of a first bobbin 40 by insert molding, for example. Likewise, terminals 30c and 30d (FIG. 1B) are attached to the terminal installation portion 62 of a second bobbin 60.

Next, a winding portion 21 is formed around a cylinder portion 61. Next, as shown in FIG. 6, lead portions 22a and 22b are drawn out from the bottom surface side of the cylinder portion 61 toward the terminals 30c and 30d and connected to wire connection portions 31c and 31d, respectively.

Next, a first core 70 is inserted into a through hole 610 of the cylinder portion 61 shown in FIG. 2. Next, the cylinder portion 61 with the first core 70 inserted therein is inserted into a through hole 410 of the cylinder portion 41 in the direction indicated by the arrow in FIG. 6.

Next, a winding portion 11 is formed around the cylinder portion 41 shown in FIG. 2. When a winding portion 21 is formed around the cylinder portion 61, however, the winding portion 11 may be formed around the cylinder portion 41. Next, as shown in FIG. 6, a lead portion 12b is drawn out from the bottom surface side of the cylinder portion 41 toward the terminal 30b and connected to a wire connection portion 31b.

Next, as shown in FIG. 8, a first cover member 90 is attached to the first bobbin 40. At this time, the lead portion 12b is disposed on the inner side of the cover body 91. Next, the lead portion 12a is drawn out via an opening 92 from the winding portion 11 toward a first surface 91a of the cover body 91. At this time, the lead portion 12a is drawn out along the first portion 92a of the opening 92 from the outer edge of the cover body 91 on the negative side of the Y-axis direction toward the inner side of the Y-axis direction. Moreover, the lead portion 12a is drawn out along the second portion 92b and is drawn out toward the terminal 30a along a second extension portion 93b of the guide portion 93. Next, the lead portion 12a is connected to a wire connection portion 31a. Note that, when the lead portion 12a is connected to the wire connection portion 31a, the above-described connection of the lead portion 12b to the wire connection portion 31b may be performed.

Next, as shown in FIG. 1B, a second cover member 100 is attached to the first bobbin 40. Next, the second core 80 is attached from above the second cover member 100. Then, as shown in FIG. 3, a leg portion 82 of the second core 80 is brought into contact with the surface of the first core 70 at a contact portion 120.

Next, as shown in FIG. 1A, a resin 110 is adhered to the end of the first core 70 on the positive side of the X-axis direction protruding from the cylinder portion 41. Then, the end of the first core 70 on the positive side of the X-axis direction is connected via the resin 110 to second stoppers 47a and 47b and an installation surface (FIG. 4A) together with the leg portion 82 of the second core 80.

Likewise, as shown in FIG. 1B, the resin 110 is adhered to the end of the first core 70 on the negative side of the X-axis direction protruding from the cylinder portion 61. Then, the end of the first core 70 on the negative side of the X-axis direction is connected via the resin 110 to the second stoppers 67a and 67b and the installation surface 63 together with the leg portion 82 of the second core 80. Accordingly, the coil device 1 can be manufactured.

In the coil device 1 of the present embodiment, as shown in FIG. 1A and FIG. 1B, the first core 70 and the terminals 30a and 30b are arranged opposite to each other in the X-axis direction via the convex portion 45. Thus, the convex portion 45 can extend the creepage distance or spatial distance (insulation distance) between the first core 70 and the terminals 30a and 30b. Thus, even if the end of the first core 70 on the positive side of the X-axis direction is disposed close to the terminals 30a and 30b, it is possible to ensure the insulation between them and achieve a compact coil device 1 with excellent (withstand voltage) reliability.

Moreover, since the convex portion 45 protrudes upward, the insulation distance between the first core 70 and the terminals 30a and 30b can be extended according to the protrusion length.

Moreover, since the convex portion 45 extends from one end to the other end of the terminal installation portion 42 along the Y-axis, a wall-like convex portion can be formed on the terminal installation portion 42. Thus, the insulation distance between the first core 70 and the terminals 30a and 30b can be extended according to the length of the convex portion 45 along the Y axis.

Moreover, since the convex portion 45 is formed at least between the terminal 30a and the terminal 30b, it is possible to prevent the insulation distance between the first core 70 and the terminals 30a and 30b from being locally shortened between them.

Moreover, as shown in FIG. 3, since the cylinder portion 61 is accommodated into the cylinder portion 41, it is possible to reduce the entire length of the bobbin along the X-axis and miniaturize the coil device 1. In particular, in the present embodiment, a compact transformer can be achieved.

Moreover, as shown in FIG. 2, even if the terminal installation portion 42 is provided with the convex portion 45 and the terminal installation portion 62 is provided with the convex portion 65, the cylinder portion is divided into the cylinder portion 41 and the cylinder portion 61, and the first core 70 can thus be inserted into the cylinder portion 61 without being hindered by the convex portion 45 or the convex portion 65.

Moreover, as shown in FIG. 1A and FIG. 3, since the end of the first core 70 on the positive side of the X-axis direction is fixed to the installation surface 50 via the resin 110 on the outer side of the contact portion 120 in the X-axis direction, it is possible to prevent the first core 70 from being positionally displaced.

Moreover, as shown in FIG. 1A, since the first stoppers 46a and 46b are contacted with the end of the first core 70 on the positive side of the X-axis direction, the first core 70 can be positioned in the X-axis direction by the first stoppers 46a and 46b. Moreover, it is possible to prevent the insulation distance between the first core 70 and the terminals 30a and 30b from varying (decreasing) due to the positional displacement of the first core 70.

Moreover, in the coil device 1 according to the present embodiment, as shown in FIG. 2 and FIG. 8, the first cover member 90 (cover body 91) is disposed between the winding portion 11 and the lead portion 12a passing over the winding portion 11 in the X-axis direction. In this case, since the winding portion 11 and the lead portion 12a are arranged opposite to each other via the cover body 91, the cover body 91 can extend a creepage distance or a spatial distance (insulation distance) between the winding portion 11 and the lead portion 12a. Thus, even if the lead portion 12a is disposed close to the winding portion 11, it is possible to ensure the insulation between them and achieve a compact and low-profile coil device 1 with excellent (withstand voltage) reliability.

Moreover, since the cover body 91 is attached to the first bobbin 40 on the side opposite to the second core 80, it is possible to ensure the insulation distance between the second core 80 and the lead portion 12a and improve the (withstand voltage) reliability of the coil device 1.

Moreover, the lead portion 12a is drawn out via the opening 92 from the winding portion 11 toward the first surface 91a of the cover body 91. Thus, when the lead portion 12a is drawn out from the winding portion 11 toward the first surface 91a, it is possible to prevent the lead portion 12a from being bent and prevent the lead portion 12a from being damaged. Moreover, since the lead portion 12a can be drawn out in a short distance from the winding portion 11 toward the first surface 91a, it is possible to increase the number of turns of the winding portion 11.

Moreover, the opening 92 extends from the outer edge of the cover body 91 on the negative side of the Y-axis direction toward the inner side of the cover body 91 in the Y-axis direction. Thus, the lead portion 12a can be guided into the opening 92 from the outer edge of the cover body 91 in the Y-axis direction toward the inner side of the Y-axis direction.

Moreover, since the guide portion 93 is formed on the first surface 91a, the lead portion 12a can be guided in a desired direction (extension direction of the guide portion 93) by drawing the lead portion 12a along the guide portion 93. Moreover, the lead portion 12a can be protected from external loads.

Moreover, since the protrusion length of the guide portion 93 is equal to or larger than the wire size of the lead portion 12a, for example, the lead portion 12a can be guided in a desired direction (extension direction of the guide portion 93) while being fixed to the guide portion 93.

### Second Embodiment

Except for the following matters, a coil device 1A according to the present embodiment has the same configurations as the coil device 1 according to First Embodiment. Overlapping members with the coil device 1 according to First Embodiment are provided with the same reference numerals and are not described in detail.

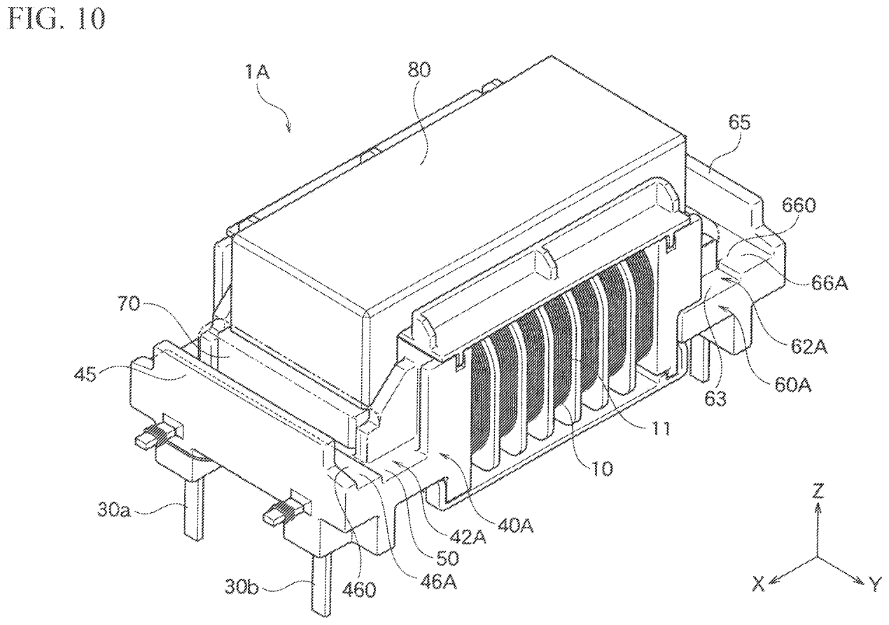

As shown in FIG. 10, the coil device 1A includes a first bobbin 40A and a second bobbin 60A. The first bobbin 40A includes a terminal installation portion 42A, and the second bobbin 60A includes a terminal installation portion 62A. The terminal installation portion 42A includes a first stopper 46A, and the terminal installation portion 62A includes a first stopper 66A.

The first stopper 46A is different from the first stopper 46 according to First Embodiment in that the first stopper 46A includes a step portion 460. The first stopper 66A is different from the first stopper 66 according to First Embodiment in that the first stopper 66A includes a step portion 660.

The step portion 460 protrudes upward from the installation surface 50 and protrudes inward in the X-axis direction from the inner surface of the convex portion 45 in the X-axis direction. The step portion 460 continuously extends along the Y-axis from one end to the other end of the terminal installation portion 42A. The length of the step portion 460 along the Y-axis is equal to the length of the convex portion 45 along the Y-axis. However, the shape and size of the step portion 460 are not limited to this. The step portion 460 may be intermittently formed along the Y-axis. Also, the length of the step portion 460 along the Y-axis may be smaller than the length of the terminal installation portion 42A along the Y-axis or the length of the convex portion 45 along the Y-axis. The upper surface of the step portion 460 is a flat surface, but may have unevenness. A step perpendicular to the installation surface 50 is formed between the upper surface of the step portion 460 and the installation surface 50.

The step portion 660 protrudes upward from the installation surface 63 and protrudes inward in the X-axis direction from the inner surface of the convex portion 65 in the X-axis direction. The step portion 660 continuously extends from one end to the other end of the terminal installation portion 62A along the Y-axis. The length of the step portion 660 along the Y-axis is equal to the length of the convex portion 65 along the Y-axis. However, the shape and size of the step portion 660 are not limited to this. The step portion 660 may be intermittently formed along the Y-axis. Also, the length of the step portion 660 along the Y-axis may be smaller than the length of the terminal installation portion 62A along the Y-axis or the length of the convex portion 65 along the Y-axis. The upper surface of the step portion 660 is a flat surface, but may have unevenness. A step perpendicular to the installation surface 63 is formed between the upper surface of the step portion 660 and the installation surface 63.

The same effects as in First Embodiment can also be obtained in the present embodiment. In particular, in the present embodiment, the first core 70 can be positioned in the X-axis direction by the step portions 460 and 660. Moreover, it is possible to prevent the variation (decrease) of the insulation distance between the first core 70 and the terminals 30a and 30b (or the terminals 30c and 30d) due to the positional displacement of the first core 70. Moreover, the insulation distance between the first core 70 and the terminals 30a and 30b (or the terminals 30c and 30d) can be extended by the step between the surfaces of the step portions 460 and 660 and the installation surfaces 50 and 63.

Note that, the present disclosure is not limited to the above-described embodiments and may variously be modified within the scope of the present disclosure. In each of the above-described embodiments, an application example of the coil device 1 to a transformer is described, but the coil device 1 can also be applied to other coil devices in addition to the transformer.

In each of the above-described embodiments, the second core 80 (FIG. 1A) may be formed by combining I-shaped cores. Moreover, in each of the above-described embodiments, as shown in FIG. 3, the annular core is formed by combining an I-shaped core and a U-shaped core, but may be formed by combining two U-shaped cores.

In each of the above-described embodiments, as shown in FIG. 2, the bobbin is formed of the first bobbin 40 and the second bobbin 60, but the number of bobbins is not limited. For example, the coil device 1 may be provided with one bobbin. Also, the coil is formed of the first coil 10 and the second coil 20, but the number of coils is not limited. For example, the coil device 1 may be provided with one coil. Also, the core is formed of the first core 70 and the second core 80, but the number of cores is not limited. Also, the terminal is formed of four terminals 30a to 30d, but the number of terminals is not limited.

In each of the above-described embodiments, if necessary, members other than the convex portion 45 may be omitted from the terminal installation portion 42. Moreover, if necessary, members other than the convex portion 65 may be omitted from the terminal installation portion 62.

In each of the above-described embodiments, if necessary, members other than the cover body 91 may be omitted from the first cover member 90 shown in FIG. 7.

### DESCRIPTION OF THE REFERENCE NUMERICAL

1, 1A . . . coil device
10 . . . first coil
11 . . . winding portion
12a, 12b . . . lead portion
20 . . . second coil
21 . . . winding portion
22a, 22b . . . lead portion
30a-30d . . . terminal
31a-31d . . . wire connection portion
32a-32d . . . external connection portion
40A . . . first bobbin
41 . . . cylinder portion
410 . . . through hole
411 . . . partition wall
42, 42A . . . terminal installation portion
43, 44 . . . flange portion
430, 440 . . . engagement groove portion
431, 432a, 432b, 441, 442a, 442b . . . engagement convex portion
433a, 433b, 443a, 443b . . . side wall portion
444 . . . engagement recess
45 . . . convex portion
450 . . . notch
46a, 46b, 46A . . . first stopper
460 . . . step portion
47a, 47b . . . second stopper
470 . . . notch
48a, 48b . . . guide portion
49a, 49b . . . protrusion portion
50 . . . installation surface
60A . . . second bobbin
61 . . . cylinder portion
610 . . . through hole
611a-611d . . . partition wall
62, 62A . . . terminal installation portion
63 . . . installation surface
65 . . . convex portion
650 . . . notch
66, 66A . . . first stopper
660 . . . step portion
67a, 67b . . . second stopper
670 . . . notch
68 . . . guide portion
69a, 69b . . . protrusion portion
70 . . . first core
80 . . . second core
81 . . . body portion
82 . . . leg portion
90 . . . first cover member
91 . . . cover body
91a . . . first surface
91b . . . second surface
92 . . . opening
92a . . . first portion
92b . . . second portion
93 . . . guide portion
93a . . . first extension portion
93b . . . second extension portion
94a-94d . . . engagement portion
940 . . . engagement hole
95 . . . engagement convex portion
100 . . . second cover member
101 . . . cover body
102a, 102b . . . engagement convex portion
103a, 103b . . . core restriction portion
104 . . . lateral convex portion
105a, 105b . . . engagement portion
106 . . . engagement hole
110 . . . resin
120 . . . contact portion

What is claimed is:

1. A coil device comprising:
a coil including:
a winding portion; and
a lead portion drawn out from the winding portion;
a terminal connected with the lead portion;
a bobbin including:
a cylinder portion for the winding portion; and
a terminal installation portion formed at an end in a first direction parallel to an axial direction of the cylinder portion and provided with the terminal; and
a core attachable to the bobbin,
wherein the terminal installation portion includes a convex portion separating the core and the terminal.

2. The coil device according to claim 1, wherein the convex portion protrudes toward a third direction perpendicular to an installation surface of the bobbin.

3. The coil device according to claim 2, wherein the convex portion extends from one end to the other end of the terminal installation portion along a second direction perpendicular to the first direction and the third direction.

4. The coil device according to claim 2, wherein a length of the convex portion is equal to or larger than a length of the core in a second direction perpendicular to the first direction and the third direction.

5. The coil device according to claim 1, wherein
the terminal comprises a pair of terminals, and
the convex portion is formed at least between the pair of terminals.

6. The coil device according to claim 1, wherein
the bobbin comprises a first bobbin and a second bobbin, and
at least a part of the second bobbin is accommodated in the first bobbin.

7. The coil device according to claim 6, wherein
the coil comprises:
a first coil including a first winding portion; and
a second coil including a second winding portion,
the first bobbin includes a first cylinder portion for the first winding portion,
the second bobbin includes a second cylinder portion for the second winding portion and for the core to be inserted, and
the second cylinder portion is inserted into the first cylinder portion.

8. The coil device according to claim 7, wherein
the convex portion comprises a first convex portion and a second convex portion,
the terminal installation portion comprises:
a first terminal installation portion formed at one end of the first cylinder portion in the first direction; and
a second terminal installation portion formed at the other end of the second cylinder portion in the first direction,
the first terminal installation portion includes the first convex portion, and
the second terminal installation portion includes the second convex portion.

9. The coil device according to claim 1, wherein
the core comprises:
a first core; and
a second core combined with the first core,
the first core is an I-shaped core,
the second core is a U-shaped core, and
the first core is inserted into the cylinder portion.

10. The coil device according to claim 9, wherein a length of the first core along the first direction is larger than a length of the second core along the first direction.

11. The coil device according to claim 10, wherein an end of the first core in the first direction is connected to the terminal installation portion via a resin on an outer side of a contact portion between the first core and the second core in the first direction.

12. The coil device according to claim 1, wherein the terminal installation portion includes a first stopper formed on an inner side of the convex portion in the first direction and contacted with an end of the core in the first direction.

13. The coil device according to claim 12, wherein the first stopper includes a step formed between an upper surface of the first stopper and an installation surface of the bobbin for the core to be mounted.

14. The coil device according to claim 3, wherein
the core is inserted in the cylinder portion,
an end of the core in the first direction protrudes outward in the first direction from the cylinder portion,
the terminal installation portion includes a second stopper adjacent to the end of the core in the first direction on an outer side of the core in the second direction, and
the second stopper is provided with a notch.

15. The coil device according to claim 1, wherein
the terminal includes an external connection portion connectable to a substrate, and
the external connection portion protrudes toward a direction opposite to a protrusion direction of the convex portion or a direction perpendicular to the protrusion direction.

16. A coil device comprising:
a coil including:
a winding portion; and
a lead portion drawn out from the winding portion;
a terminal connected with the lead portion;
a bobbin including:
a cylinder portion for the winding portion; and
a terminal installation portion formed at an end in a first direction parallel to an axial direction of the cylinder portion and provided with the terminal;
a core attachable to the bobbin; and
a cover member disposed between the winding portion and the lead portion passing over the winding portion.

17. The coil device according to claim 16, wherein
the lead portion is drawn out over the winding portion toward the terminal on an opposite side of the core, and
the cover member is attached to the bobbin on the opposite side of the core.

18. The coil device according to claim 16, wherein
the cover member includes:
a cover body; and
an opening formed on the cover body, and
the lead portion is drawn out via the opening from the winding portion toward a first surface of the cover body, which is an opposite surface to a surface of the cover body facing the winding portion.

19. The coil device according to claim 18, wherein the opening extends from an outer edge of the cover body toward an inner side of the cover body.

20. The coil device according to claim 16, wherein
the cover member includes:
a cover body; and
a first guide portion formed on the cover body and protruding from the cover body, and
the first guide portion is formed on a first surface of the cover body, which is an opposite surface to a surface of the cover body facing the winding portion.

21. The coil device according to claim 20, wherein at least a part of the first guide portion extends along the first direction.

22. The coil device according to claim 20, wherein a height of the first guide portion is equal to or larger than a wire diameter of the lead portion.

23. The coil device according to claim 16, wherein the terminal installation portion includes a second guide portion protruding toward the opposite side of the core.

24. The coil device according to claim 23, wherein the second guide portion protrudes in the same direction as the first guide portion and extends along the first direction.
